(19) United States
(12) Patent Application Publication
(10) Pub. No.: US 2025/0388339 A1
(43) Pub. Date: Dec. 25, 2025

(54) MULTIMODAL INSPECTION OF LARGE-SCALE SURFACES USING VEHICLE-BORNE SENSORS

(71) Applicants: THE BOEING COMPANY, Arlington, VA (US); Siemens Corporation, Princeton, NJ (US)

(72) Inventors: Veniamin V. STRYZHEUS, Kent, WA (US); Brian T. MILLER, Auburn, WA (US); Matthew J. CHEN, Seattle, WA (US); Micah K. JOHNSON, Nashua, NH (US); Abhiroop AJITH, Berkeley, CA (US); Chengtao WEN, Redwood City, CA (US); Jose Luis SUSA RINCON, Pittsburg, CA (US); Justinian ROSCA, New York, NY (US)

(21) Appl. No.: 18/753,741

(22) Filed: Jun. 25, 2024

(51) Int. Cl. B64F 5/60; B64F 5/10; B64F 5/50; G06T 7/00; G06T 7/55; G06T 7/73

(52) U.S. Cl. CPC B64F 5/60; B64F 5/10; B64F 5/50; G06T 7/0004; G06T 7/55; G06T 7/75; G06T 2207/20084

(57) ABSTRACT

The present disclosure provides a method of inspection of a surface of an aerodynamic structure. The method includes acquiring image(s) of the surface using image sensor(s) disposed adjacent to the surface, and determining, using the image(s) applied to a model, predicted defect(s) of the surface and corresponding location information. The method further includes controlling, using the location information, the position of tactile sensor(s) disposed adjacent to the surface to acquire dimensioning information for at least a first predicted defect of the predicted defect(s). The method further includes characterizing the first predicted defect using the dimensioning information.

### STATEMENT OF GOVERNMENT INTEREST

This invention was made with government support under contract #ARM-TEC-21-02-F-15 awarded by the Department of Defense. The government has certain rights in the invention.

### FIELD

Aspects of the present disclosure relate to process monitoring and inspection for small features and defects on large-scale components and structures, and more specifically, employing collaborative robots to automate inspection in a manufacturing environment.

### BACKGROUND

Within large-scale manufacturing and industries using large-scale components (such as the aviation industry), various factors such as vibration, foreign object debris, high temperature, friction, and corrosion can affect the performance and longevity of the components (e.g., causing premature fatigue or failure). Many industries require surface inspection of the large-scale components to ensure continued safe operation.

Surface inspection is conventionally performed by human technicians, which is a time-consuming process and often subject to inconsistency due to the qualitative nature of the specification. For example, the specification may require that scratches and gouges in a surface be inspected by a technician using a fingernail, although various factors can bias the technician's sensitivity. Further, for some types of surface inspection tools (such as dial indicators), it can be challenging to establish a baseline for a defect on curved surfaces or complex contoured surfaces.

From a technological perspective, a sensor having a small field of view (FOV) can perform surface inspection with suitable accuracy, but sweeping the sensor across the entire surface area of a large-scale component (e.g., an aircraft fuselage) is impracticable. A sensor having a large FOV can obtain large amounts of data over a wide area, but the data typically does not have sufficient accuracy to measure defects in the surface. Other techniques for defect inspection include laser-line systems and structured light scanners, but neither is capable of measuring sharp discontinuities (e.g., scratches, gouges, drill runs, etc.) with an accuracy suitable for the aviation industry.

### SUMMARY

The present disclosure provides a method of inspection of a surface of an aerodynamic structure in one aspect, the method including: acquiring one or more images of the surface using one or image sensors disposed adjacent to the surface, and determining, using the one or more images applied to a model, one or more predicted defects of the surface and corresponding location information. The method further includes controlling, using the location information, the position of one or more tactile sensors disposed adjacent to the surface to acquire dimensioning information for at least a first predicted defect of the one or more predicted defects. The method further includes characterizing the first predicted defect using the dimensioning information.

In one aspect, in combination with any example method above or below, the method further includes: applying the one or more images to a machine learning model to identify the one or more predicted defects and the location information, and selecting, using confidence information corresponding to the one or more predicted defects, at least a first predicted defect from the one or more predicted defects. The method further includes providing, using the location information corresponding to the first predicted defect, a control signal to the vehicle to position a first tactile sensor of the one or more tactile sensors to acquire the dimensioning information for the first predicted defect.

In one aspect, in combination with any example method above or below, the first image sensor of the one or more image sensors, used to acquire the one or more images, and the first tactile sensor are colocated on a vehicle disposed adjacent to the surface.

In one aspect, in combination with any example method above or below, selecting at least a first predicted defect includes selecting, based on a comparison of the confidence information with a threshold value, a set of the one or more predicted defects for tactile sensing. Selecting at least a first predicted defect further includes allocating the predicted defects of the set among one or more vehicles disposed adjacent to the surface, and scheduling the predicted defects of the set among the one or more vehicles.

In one aspect, in combination with any example method above or below, allocating the predicted defects of the set among the one or more vehicles includes applying one or more goals. The one or more goals includes one or more of balancing a workload between the one or more vehicles, and minimizing an overall inspection time.

In one aspect, in combination with any example method above or below, scheduling the predicted defects of the set among the one or more vehicles includes applying one or more goals. The one or more goals includes one or more of minimizing conflicts between the one or more vehicles, and minimizing a travel time of the one or more vehicles.

In one aspect, in combination with any example method above or below, the method further includes adjusting the threshold value, and selecting, based on a comparison of the confidence information with the adjusted threshold value, a second set of the one or more predicted defects for tactile sensing.

In one aspect, in combination with any example method above or below, acquiring the dimensioning information for the first predicted defect includes determining one or more of a depth profile, a width, a length, and a sharpness of a bottom basin for the first predicted defect.

In one aspect, in combination with any example method above or below, characterizing the first predicted defect using the dimensioning information includes characterizing the first predicted defect as one of a drill run, a scratch, and a gouge.

The present disclosure provides a computer program product in one aspect, the computer program product including a computer-readable storage medium having computer-readable program code embodied therewith. The computer-readable program code is executable by one or more computer processors to perform an operation that includes: acquiring one or more images of surface of an aerodynamic structure using one or image sensors, and determining, using the one or more images applied to a model, one or more predicted defects of the surface and corresponding location information. The operation further includes controlling, using the location information, the position of one or more tactile sensors to acquire dimensioning information for at least a first predicted defect of the one or more predicted defects. The operation further includes characterizing the first predicted defect using the dimensioning information.

In one aspect, in combination with any example computer program product above or below, the operation further includes applying the one or more images to a machine learning model to identify the one or more predicted defects and the location information, and selecting, using confidence information corresponding to the one or more predicted defects, at least a first predicted defect from the one or more predicted defects. The operation further includes providing, using the location information corresponding to the first predicted defect, a control signal to the vehicle to position a first tactile sensor of the one or more tactile sensors to acquire the dimensioning information for the first predicted defect.

In one aspect, in combination with any example computer program product above or below, a first image sensor of the one or more image sensors, used to acquire the one or more images, and the first tactile sensor are colocated on a vehicle disposed adjacent to the surface.

In one aspect, in combination with any example computer program product above or below, selecting at least a first predicted defect includes selecting, based on a comparison of the confidence information with a threshold value, a set of the one or more predicted defects for tactile sensing. Selecting at least a first predicted defect further includes allocating the predicted defects of the set among one or more vehicles disposed adjacent to the surface, and scheduling the predicted defects of the set among the one or more vehicles.

In one aspect, in combination with any example computer program product above or below, allocating the predicted defects of the set among the one or more vehicles includes applying one or more goals. The one or more goals includes one or more of balancing a workload between the one or more vehicles, and minimizing an overall inspection time.

In one aspect, in combination with any example computer program product above or below, scheduling the predicted defects of the set among the one or more vehicles includes applying one or more goals. The one or more goals includes one or more of minimizing conflicts between the one or more vehicles, and minimizing a travel time of the one or more vehicles.

In one aspect, in combination with any example computer program product above or below, the operation further includes adjusting the threshold value, and selecting, based on a comparison of the confidence information with the adjusted threshold value, a second set of the one or more predicted defects for tactile sensing.

In one aspect, in combination with any example computer program product above or below, acquiring the dimensioning information for the first predicted defect includes determining one or more of a depth profile, a width, a length, and a sharpness of a bottom basin for the first predicted defect.

In one aspect, in combination with any example computer program product above or below, characterizing the first predicted defect using the dimensioning information includes characterizing the first predicted defect as one of a drill run, a scratch, and a gouge.

The present disclosure provides a system in one aspect, the system including one or more image sensors disposed adjacent to a surface of an aerodynamic structure, and one or more tactile sensors disposed adjacent to the surface. The system further includes one or more processors configured to: acquire one or more images of the surface using the one or image sensors, and determine, using the one or more images applied to a model, one or more predicted defects of the surface and corresponding location information. The one or more processors are further configured to control, using the location information, the position of the one or more tactile sensors to acquire dimensioning information for at least a first predicted defect of the one or more predicted defects. The one or more processors are further configured to characterize the first predicted defect using the dimensioning information.

In one aspect, in combination with any example system above or below, a first image sensor of the one or more image sensors, used to acquire the one or more images, and the first tactile sensor are colocated on a vehicle disposed adjacent to the surface.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 is a block diagram an exemplary system for inspection of a surface of an aircraft fuselage, according to one or more aspects.

FIG. 2 is a perspective view of an exemplary system for inspection of a surface of an aircraft fuselage, according to one or more aspects.

FIG. 3 is a perspective view of an exemplary vehicle with a robotic arm, according to one or more aspects.

FIG. 4 is a diagram of an exemplary mount for coupling multiple sensors to a robotic arm, according to one or more aspects.

FIG. 5 is a perspective view of multiple sensors coupled to a robotic arm through a mount, according to one or more aspects.

FIGS. 6A and 6B depict an exemplary method of inspection of a surface of an aircraft fuselage, according to one or more aspects.

FIG. 7 is an exemplary method of selecting a predicted defect for tactile sensing using confidence information for the predicted defect, according to one or more aspects.

FIG. 8 is a diagram illustrating an exemplary sequence of detecting and classifying one or more predicted defects of a surface, according to one or more aspects.

FIG. 9 is a diagram illustrating an exemplary inspection process, according to one or more aspects.

FIG. 10 is a diagram illustrating an exemplary multi-robot scheduling service, according to one or more aspects.

### DETAILED DESCRIPTION

The present disclosure provides a system for inspection of a surface of an aerodynamic structure, such as an aircraft fuselage. In some aspects, the system comprises a track overlapping with a section of the surface, and one or more vehicles constrained to travel along the track. The system further comprises one or more image sensors and one or more tactile sensor disposed on the one or more vehicles. In some aspects, the system provides a two-stage inspection of the aircraft fuselage. In a first stage, the image sensor(s) (e.g., an RGB camera) acquire image(s) of the surface, which are provided to a model to predict any defects of the surface. Those predicted defects having a low confidence are provided to a second stage, where the tactile sensor(s) performs a tactile scan of the predicted defects to identify and classify the predicted defects. In some aspects, both the image sensor(s) and the tactile sensor(s) are mounted to a robotic arm, making the system well-suited for inspection in a production environment.

The two-stage approach allows large surfaces to be efficiently scanned for small anomalies. In the first stage, predicting defects using image(s) of the surface can be achieved with a relatively fast prediction speed, but typically provides lesser accuracy as the visual appearance of the defects can be influenced by many sources of noise. In the second stage, the higher-resolution tactile sensor(s) are relatively slower (e.g., providing a smaller coverage area of the surface per scan) but are employed selectively to disambiguate only those predicted defects having a low confidence. Using the two-stage approach, a complete (e.g., approximately 100%) identification of defects of the surface can be achieved in less time than an approach using only tactile sensor(s), and with greater accuracy than an approach using only image sensor(s).

In some applications, the second stage is selectively invoked to detect and classify the predicted defects. In other applications, the second stage may be invoked on all predicted defects. For predicted defects with “high confidence”, the higher-resolution scans of the second stage are used to perform measurements of the predicted defects. For predicted defects with “low confidence”, the higher-resolution scans are used to improve the classification confidence and/or to perform the measurements of the predicted defects.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

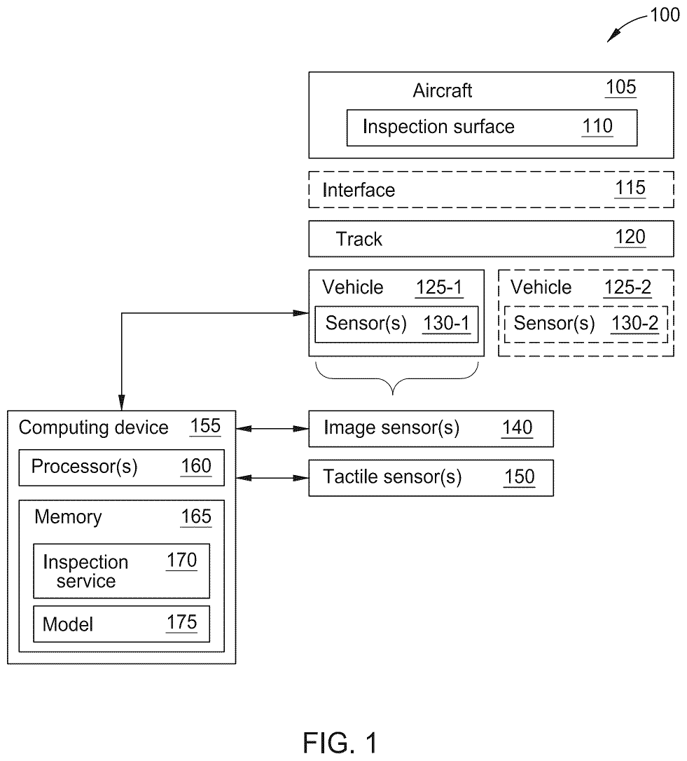

FIG. 1 is a block diagram of an exemplary system 100 for inspection of a surface of an aircraft fuselage, according to one or more aspects. The system 100 comprises an aircraft 105 having an inspection surface 110 (also referred to as a “surface”). The aircraft 105 may be in a partially assembled state or a fully assembled state. The inspection surface 110 may belong to any suitable section(s) of the aircraft 105, such as the fuselage, wing(s), empennage, and so forth. Further, in some aspects, the inspection surface 110 may belong to a component that is separate from the aircraft 105 (e.g., prior to installation or assembly). Thus, within an aircraft manufacturing setting, the system 100 may perform inspection in any one of various tiers: component-level inspection in a work-cell, aircraft hot-spot inspection such as a section join area or a door surround, and full aircraft inspection. It will be noted that the system 100 may be used in conjunction with other types of aerodynamic structures.

The system 100 further comprises a track 120 that overlaps with a section of the surface 110, and one or more vehicles 125-1, 125-2 that are constrained to travel along the track 120. In some aspects, the track 120 comprises one or more rails, and the one or more vehicles 125-1, 125-2 are arranged to roll or slide on the one or more rails. For example, the one or more vehicles 125-1, 125-2 may include one or more wheels, tracks, skids, etc. that contact the one or more rails of the track 120. In another example, the track 120 may include the one or more wheels, tracks, skids, etc. that engage with corresponding portions of the one or more vehicles 125-1, 125-2. In some aspects, the track 120 includes one or more retaining features that retain the one or more vehicles 125-1, 125-2 on the track 120. In some aspects, the one or more vehicles 125-1, 125-2 include an actuator that moves the one or more vehicles 125-1, 125-2 along the track 120. For example, the actuator may include an electric motor that drives the wheels or tracks of the one or more vehicles 125-1,125-2. Other implementations of the track 120 and the one or more vehicles 125-1, 125-2 are also contemplated.

The track 120 may be formed of any suitable materials providing sufficient strength to support the travel of the one or more vehicles 125-1, 125-2. For example, the one or more rails of the track 120 may be formed of a metal material, such as aluminum. The track 120 may be contoured such that the travel of the one or more vehicles 125-1, 125-2 provides a desired coverage of the inspection surface 110 by one or more sensors 130-1, 130-2 that are implemented on the one or more vehicles 125-1, 125-2. In some aspects, the track 120 is contoured to match a contour of the inspection surface 110. For example, where the surface 110 is part of an aircraft fuselage with a cylindrical external profile, the one or more rails of the track 120 may be curved with a same or similar radius of curvature as the aircraft fuselage. In some cases, the track 120 may be dimensioned to maintain the one or more vehicles 125-1, 125-2 at a predefined distance (e.g., with a standoff) from the inspection surface 110.

In some aspects, the track 120 is removably attached to the surface 110. In some aspects, the track 120 contacts the surface 110 directly. In other aspects, the track 120 is attached to the surface 110 through an interface 115. In some aspects, the interface 115 is formed of a different material than the track 120 (e.g., a compliant material such as silicone rubber or foam) to improve a uniformity of contact with the surface 110 and/or to reduce the likelihood of damage to the surface 110 from contact with the track 120.

Each of the one or more vehicles 125-1, 125-2 comprises a respective one or more sensors 130-1, 130-2. The one or more sensors 130-1, 130-2 may be integrated into the one or more vehicles 125-1, 125-2 or attached thereto. In some aspects, the one or more sensors 130-1, 130-2 comprise a plurality of sensors that are colocated on the respective vehicle 125-1, 125-2. In some aspects, each of the one or more vehicles 125-1, 125-2 comprises a respective robotic arm and the one or more sensors 130-1, 130-2 are coupled to a distal end of the robotic arm. In some aspects, the robotic arm is controlled to position the one or more sensors 130-1, 130-2 relative to the surface 110.

In some aspects, the one or more sensors 130-1, 130-2 comprises one or more image sensors 140 and one or more tactile sensors 150. In some aspects, an image sensor 140 and a tactile sensor 150 are colocated on a vehicle of the one or more vehicles 125-1, 125-2. In some aspects, one or both of the image sensor 140 and the tactile sensor 150 are articulatable relative to the vehicle 125 (e.g., relative to a base section of the vehicle 125). The one or more image sensors 140 acquire one or more images of the surface 110 that are used to identify one or more predicted defects of the surface 110. The one or more tactile sensors 150 acquire, using location information derived from the one or more images, dimensioning information corresponding to the one or more predicted defects. In some aspects, the one or more tactile sensors 150 are employed for only those of the one or more predicted defects having a low confidence.

The one or more image sensors 140 and the one or more tactile sensors 150 may have any suitable implementation. In some aspects, the one or more image sensors 140 comprise a 2D RGB camera having any suitable resolution (e.g., 1920×1080 or greater), and the one or more tactile sensors 150 comprise a 3D surface analysis sensor having any suitable resolution (e.g., micron-level sensitivity in one or more dimensions). In one non-limiting example, the one or more image sensors 140 comprise an Intel® RealSense™ Depth Camera D435, and the one or more tactile sensors 150 comprises a GelSight Mobile™. Other types and combinations of sensors are also contemplated, such as line scan cameras. Further, in some aspects, the system 100 further comprises lighting devices in combination with the one or more image sensors 140, such as structured light systems, oblique-angle lighting, high-speed strip lights, and so forth.

In some embodiments, the one or more image sensors 140 have a larger field of view (FOV) than the FOV of the one or more tactile sensors 150. In some aspects, the resolution of the one or more image sensors 140 is less than the resolution of the one or more tactile sensors 150. Further, in some aspects, the one or more image sensors 140 or the one or more tactile sensors 150 may be substituted to be of a same type as each other. For example, in an alternate implementation, the system 100 comprises one or more image sensors 140 having a lower resolution, and one or more image sensors having a higher resolution. Although higher-resolution sensor(s) tend to be relatively slower (e.g., providing a smaller coverage area of the surface 110 per scan), according to aspects described herein the higher-resolution sensor(s) may be employed selectively.

The system 100 further comprises an electronic device 155 that is communicatively coupled with the one or more vehicles 125-1, 125-2, and with the one or more image sensors 140 and the one or more tactile sensors 150. As used herein, an “electronic device” generally refers to any device having electronic circuitry that provides a processing or computing capability, and that implements logic and/or executes program code to perform various operations that collectively define the functionality of the electronic device. The functionality of the electronic device includes a communicative capability with one or more other electronic devices, e.g., when connected to a same network. An electronic device may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any suitable techniques, such as conductive cabling, wireless transmission, optical transmission, and so forth. Further, although described as being performed by a single electronic device, in other aspects, the functionalities of the system 100 may be performed by a plurality of electronic devices.

The electronic device 155 comprises one or more processors 160 and a memory 165. The one or more processors 160 are any electronic circuitry, including, but not limited to one or a combination of microprocessors, microcontrollers, application-specific integrated circuits (ASIC), application-specific instruction set processors (ASIP), and/or state machines, that is communicatively coupled to the memory 165 and controls the operation of the system 100. The one or more processors 160 are not limited to a single processing device and may encompass multiple processing devices.

The one or more processors 160 may include other hardware that operates software to control and process information. In some aspects, the one or more processors 160 execute software stored in the memory 165 to perform any of the functions described herein. The one or more processors 160 control the operation and administration of the electronic device 155 by processing information (e.g., information received from input devices and/or communicatively coupled electronic devices).

The memory 165 may store, either permanently or temporarily, data, operational software, or other information for the one or more processors 160. The memory 165 may include any one or a combination of volatile or non-volatile local or remote devices suitable for storing information. For example, the memory 165 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 165, a disk, a CD, or a flash drive. In particular embodiments, the software may include an application executable by the one or more processors 160 to perform one or more of the functions described herein.

In this example, the memory 165 stores an inspection service 170 that acquires various scans from the one or more image sensors 140 and the one or more tactile sensors 150. In some aspects, the inspection service 170 provides control signals to the vehicles 125-1, 125-2 to control the positioning (e.g., location and/or orientation) thereof along the track 120. For example, the inspection service 170 may drive electric motors of the vehicles 125-1, 125-2. Where applicable, the inspection service 170 provides control signals to the robotic arm to control the positioning (e.g., location and/or orientation) thereof relative to a base portion of the vehicles 125-1, 125-2. Collectively, the inspection service 170 controls the positioning of the one or more image sensors 140 and the one or more tactile sensors 150 when acquiring the scans. In some aspects, the inspection service 170 acquires some or all of the scans according to predefined patterns (e.g., performing a “sweep” of the inspection surface 110).

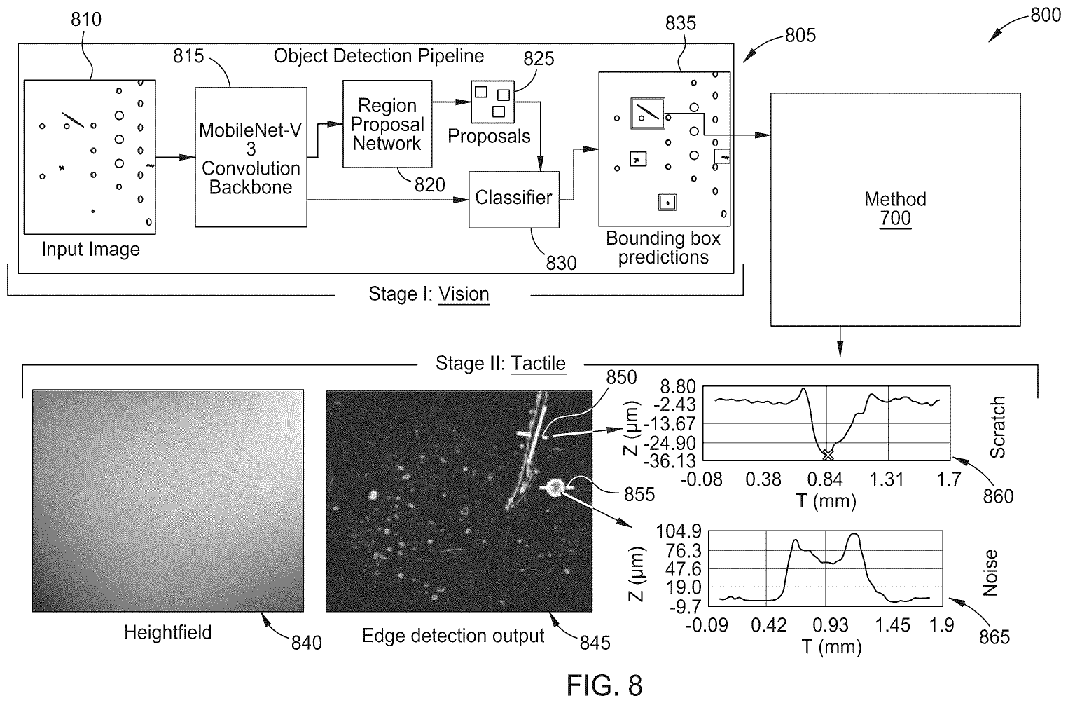

In some aspects, the inspection service 170 performs a two-stage inspection of the surface 110. In a first stage, the one or more image sensors 140 acquire one or more images of the surface 110 based on the positioning specified by the inspection surface 170. The one or more images are provided to a model 175 to predict any defects of the surface 110. In some aspects, the inspection service 170 performs preprocessing of the one or more images (or other data augmentation techniques) before providing them to the model 175. For example, the inspection service 170 may perform one or more photometric adjustment operations, one or more cut-and-paste operations, and one or more translation operations on the one or more images. The model 175 may have any suitable implementation. In some aspects, the model 175 comprises a machine learning model, such as a convolutional neural network (CNN) that may be pretrained using any suitable dataset. One example implementation of the model 175 is described below with respect to FIG. 8.

In some aspects, the model 175 provides location information and confidence information for the one or more predicted defects of the surface 110. In certain applications requiring only detection and classification of the one or more predicted defects, the inspection service 170 confirms those predicted defect(s) having a suitably large confidence (e.g., greater than a first threshold value) as a defect without requiring further analysis. Similarly, the inspection service 170 confirms those predicted defect(s) having a suitable small confidence (e.g., less than a second threshold value that is less than the first threshold value) as not a defect without requiring further analysis.

For those predicted defect(s) having a confidence in a range between the first threshold value and the second threshold value, the inspection service 170 performs a second stage analysis using the one or more tactile sensors 150. The first threshold value and the second threshold value may be selected to provide a desired balance between first stage detections and minimal second stage false positives.

In other applications, measurements of the one or more predicted defects may be required. In some aspects, the inspection service 170 performs the second stage analysis regardless of the confidence information associated with the one or more predicted defects.

In some aspects, the inspection service 170 determines one or more characteristics of the predicted defect(s) using the one or more tactile sensors 150. Some non-limiting examples of the one or more characteristics include a depth profile, a width, a length, a sharpness of the bottom basin, and so forth. In some aspects, the one or more images acquired by the one or more image sensors 140 are insufficient to determine the one or more characteristics (e.g., too low a resolution, unable to determine depth). The inspection service 170 classifies the predicted defect(s) using the one or more characteristics.

Beneficially, the two-stage approach allows large surfaces 110 to be efficiently scanned for small anomalies, sharp discontinuities, fastener installation quality, and so forth. Although higher-resolution tactile scans tend to be relatively slower, the higher-resolution tactile scans are acquired by the inspection service 170 to disambiguate only those predicted defects having a low confidence. Further, in other applications requiring measurements to be performed on all predicted defects, the “high confidence” predicted defects are measured using the higher-resolution tactile scans, but the overall outcome is faster and more accurate than performing the scans manually. Thus, a complete (e.g., approximately 100%) identification of defects of the surface 110 can be achieved in less time than an approach using only tactile sensor(s), and with greater accuracy than an approach using only image sensor(s).

In some aspects, as defect detection is often performed during the manufacturing process of the aircraft 105, the coordinated use of the one or more image sensors 140 and the one or more tactile sensors 150 along the track 120 allows other, parallel work to be performed on the aircraft 105. For example, human operators may perform assembly on adjacent sections of the aircraft 105, inspectors may inspect (or validate) assembly of the aircraft 105 alongside the system 100 providing consistent and numerical results, and so forth. In another example, the inspection service 170 performs the first stage of the two-stage inspection contemporaneously with assembly operations being performed on the aircraft 105, and performs the second stage of the two-stage inspection after the assembly operations are complete and only where the first stage has identified predicted defects (with low confidence).

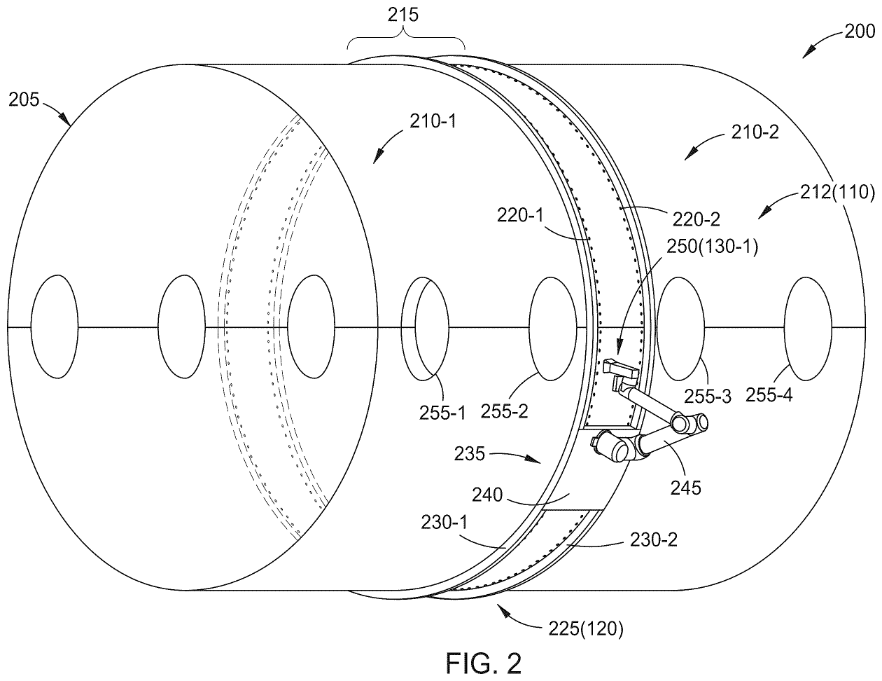

FIG. 2 is a perspective view 200 of an exemplary system for inspection of a surface of an aircraft fuselage 205, according to one or more aspects. The various features depicted in FIG. 2 may be used in conjunction with other aspects. For example, the system may represent one example of the system 100 of FIG. 1. Further, although the features are described in terms of the aircraft fuselage 205, these features are also applicable to surface inspection operations in other industries, especially those involving large-scale components.

The view 200 depicts a portion of an aircraft fuselage 205 (also referred to as a “fuselage 205”). The fuselage 205 has a substantially cylindrical profile and may be formed of any suitable materials, such as aluminum, aluminum alloys, carbon fiber, and so forth. The fuselage 205 comprises two fuselage sections 210-1, 210-2 that are joined together to form a substantially continuous surface 212 of the fuselage 205. The surface 212 represents one example of the inspection surface 110 of FIG. 1. The fuselage section 210-1 defines portholes 255-1, 255-2 and the fuselage section 210-2 defines portholes 255-3, 255-4.

The fuselage sections 210-1, 210-2 are joined together at a joint section 215 that extends circumferentially around the fuselage 205. The fuselage sections 210-1, 210-2 are joined using any suitable techniques. For example, the joint section 215 may be a butt joint with joining plates, a lap joint, and so forth. In some aspects, the joint section 215 comprises two rows 220-1, 220-2 of fasteners (e.g., rivets) that extend through respective one(s) of the fuselage sections 210-1, 210-2, joining them together directly or through joining plates. Each of the rows 220-1, 220-2 extend circumferentially around the fuselage 205. Although two rows 220-1, 220-2 are shown, any suitable number of rows and/or alternate arrangements of the fasteners relative to the fuselage sections 210-1, 210-2 are also contemplated.

In the view 200, a track 225 is disposed around the fuselage 205. The track 225 represents one example of the track 120 of FIG. 1. In some aspects, and as shown, the track 225 extends in a circumferential direction around the fuselage 205. In other aspects, the track 225 may extend only partly around the fuselage 205, and/or may extend in another direction relative to the fuselage 205 (e.g., longitudinally).

The track 225 defines a plurality of rails 230-1, 230-2 along which a vehicle 235 travels. The vehicle 235 represents one example of the vehicles 125-1, 125-2 of FIG. 1. Although two rails 230-1, 230-2 are shown, other numbers of rails (e.g., one, three or more) are also contemplated. Each of the rails 230-1, 230-2 may be formed as singular components, or may be formed of multiple components that are selectively attached together. Further, the rails 230-1, 230-2 may be coupled together in a fixed arrangement, or may be separate from each other.

The track 225 may be formed of any suitable materials that provide sufficient strength to support travel of the vehicle 235. In some aspects, the rails 230-1, 230-2 contact the surface 212, either directly or through an interface formed of a different material. For example, the interface may be formed of a compliant material, such as silicone rubber or foam, that improves a uniformity of contact with the surface 212 and/or reduces the likelihood of damage to the surface 212 (e.g., avoids scratches). In some aspects, the track 225 may be selectively attached to the fuselage 205, e.g., by clamping or otherwise tightening the track 225, or by applying force to the track 225 toward the surface 212. In other aspects, the rails 230-1, 230-2 do not contact the surface 212, and may be arranged in some cases to maintain the vehicle 235 at a predefined distance (e.g., with a standoff) from the surface 212.

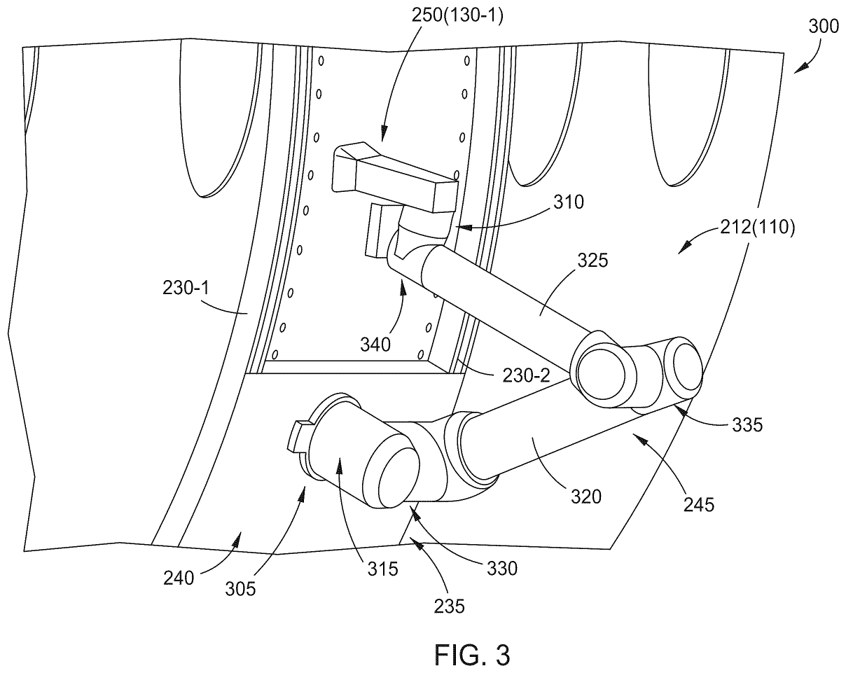

The vehicle 235 is constrained to travel along the track 225. In some aspects, which is also shown in greater detail in view 300 of FIG. 3, the vehicle 235 comprises a base section 240 that contacts the rails 230-1, 230-2, and an actuator (not shown) that moves the base section 240 along the track 220. The base section 240 may be formed of any suitable materials, and is contoured to interface with the rails 230-1, 230-2.

The vehicle 235 further comprises a robotic arm 245 having a first end 305 (e.g., a proximal end) coupled with the base section 240, and an opposing second end 310 (e.g., a distal end) coupled with one or both of a first image sensor of the one or more image sensors 140, and a first tactile sensor of the one or more tactile sensors 150. As shown, the robotic arm 245 is coupled with a sensor 250 at the second end 310, which is representative of the one or both of the first image sensor and the first tactile sensor.

The robotic arm 245 may have any suitable implementation. In some aspects, the robotic arm 245 is an articulated robotic arm having six degrees of freedom. The robotic arm 245 comprises a base joint 315 that is coupled to the base section 240 and to a shoulder joint 330, a first link 320 (e.g., an upper arm portion) extending from the shoulder joint 330 to an elbow joint 335, and a second link (e.g., a lower arm portion) extending from the elbow joint 335 to a first wrist joint 340. In some aspects, the robotic arm 245 includes two additional wrist joints, which are not shown for simplicity. The sensor 250 is attached to the robotic arm 245 near the first wrist joint 340. In some aspects, the base joint 315 and the first wrist joint 340 are implemented as twisting joints, and the shoulder joint 330 and the elbow joint 335 are implemented as rotational joints.

In some aspects, the track 225 is positioned near the joint section 215 to allow inspection thereof using the sensor 250. More specifically, the sensor 250 may be used to acquire scans of the joint section 215 to inspect the quality of the fastener installation. As shown, the track 225 overlaps with the joint section 215, although the track 225 may be disposed with any other positioning such that the joint section 215 is within the reach of the robotic arm 245.

In some aspects, the inspection service 170 positions the vehicle 235 and/or the robotic arm 245 to acquire scans of predetermined portions of the surface 212 that are more susceptible to defects, such as the joint section 215. In other aspects, the inspection service 170 performs a full “sweep” with the vehicle 235 and/or the robotic arm 245 to acquire scans of the entire coverage of the surface 212.

In some aspects, after completing the desired scans while the track 225 is in a first position relative to the fuselage 205, the track 225 may be detached from the fuselage 205, moved to a second position (e.g., along a longitudinal dimension of the fuselage 205), and reattached to the fuselage 205. The second position may be predetermined (e.g., a predetermined distance from the first position to enable a systematic coverage of the surface 212), or dynamically determined (e.g., an area of interest identified by a human operator). In some alternate aspects, the track 225 may remain in a static position while the fuselage 205 is moved. The sensor 250 may then acquire scans near the second position of the track 225. In some aspects, a human operator may reposition the track 225 and/or the fuselage 205. In other aspects, one or more actuators may reposition the track 225 and/or the fuselage 205, e.g., using control signals from the inspection service 170. For example, each of the rails 230-1, 230-2 may be coupled to a longitudinal rail, and a human operator or actuator slides the rails 230-1, 230-2 to a different longitudinal position.

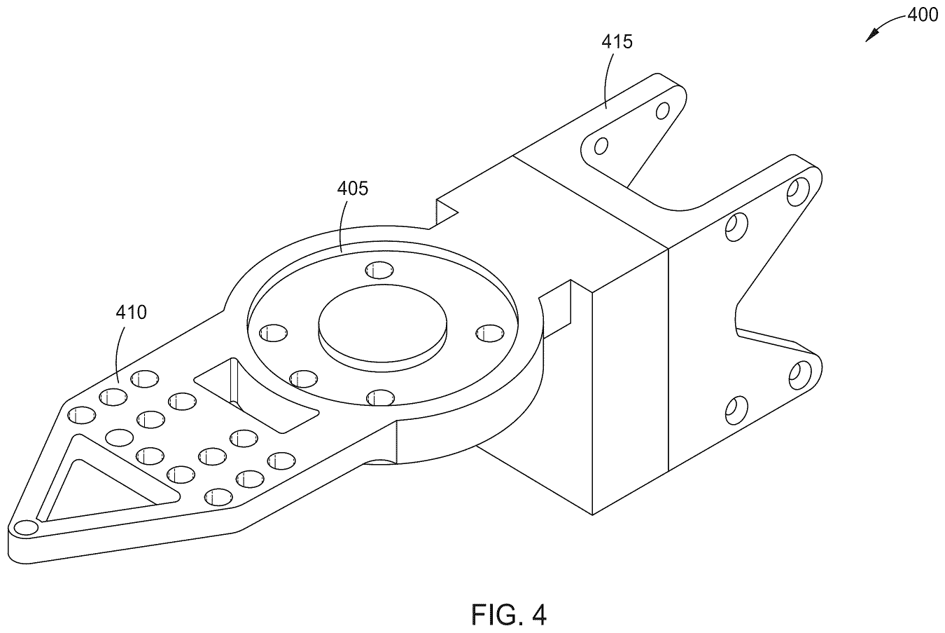

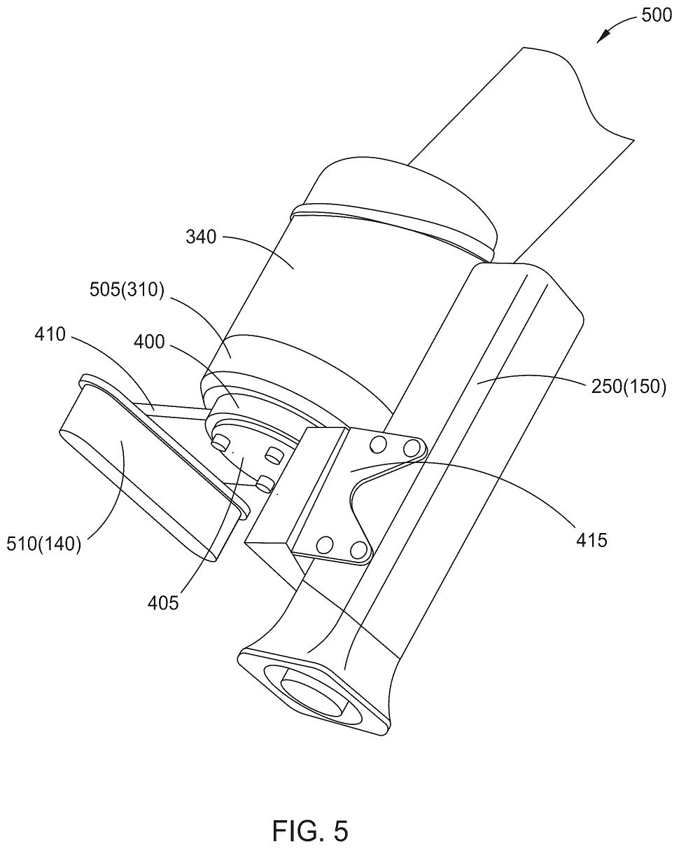

FIG. 4 is a diagram of an exemplary mount 400 for coupling multiple sensors to the robotic arm 245, according to one or more aspects. FIG. 5 provides a perspective view 500 of multiple sensors coupled to the robotic arm 245 through the mount 400. The features illustrated in FIG. 4 and FIG. 5 may be used in conjunction with other aspects. For example, the mount 400 may be used to couple an image sensor 140 and a tactile sensor 150 to an interface 505 at the second end 310 (e.g., distal end) of the robotic arm 245.

The mount 400 may be implemented as a singular component or as an assembly of multiple components. The mount 400 may be formed of any suitable materials having sufficient strength for attaching to the robotic arm 245, and to the image sensor 140 and the tactile sensor 150. For example, the mount 400 may be formed of a metal material, such as aluminum or steel, or a heavy plastic material, such as Acrylonitrile Butadiene Styrene (ABS) or High Density Polyethylene (HDPE).

The mount 400 comprises a central section 405 that is contoured to mate with the interface 505 of the robotic arm 245, a flange 410 extending in a first direction from the central section 410, and a forked bracket 415 extending in a second direction from the central section 410. In some aspects, the flange 410 and the forked bracket 415 extend in opposite directions along a same dimension (e.g., along a line within, or parallel to, a plane of the central section 405). In other aspects, the flange 410 and the forked bracket 415 extend in a same direction or along different dimensions.

In some aspects, the central section 405 defines a recessed portion from a top surface of the mount 400. The central section 405 receives a corresponding portion of the interface 505, and the central section 405 is contoured to mate with corresponding portions of the interface 505. In some aspects, the central section 405 defines a plurality of throughholes that may receive threaded fasteners therethrough to attach the mount 400 to the interface 505.

The flange 410 defines a plurality of throughholes that may receive threaded fasteners therethrough to attach to the flange 410 to a first sensor 510 (e.g., the image sensor 140). The forked bracket 415 comprises fins spaced apart from each other, each of the fins defining a plurality of throughholes that may receive threaded fasteners therethrough to attach to the forked bracket 415 to a second sensor 250 (e.g., the tactile sensor 150). Various types of attachment other than threaded fasteners are also contemplated, such as latches, detents, and so forth.

In some aspects, the flange 410 and the forked bracket 415 provide the image sensor 140 and the tactile sensor 150 with a same orientation (e.g., having fully or partly overlapping fields of view). As shown, the fins of the forked bracket 415 are disposed in respective planes that are perpendicular to a plane of the flange 410. In alternate aspects, the mount 400 may include multiple flanges 410, multiple forked brackets 415, etc. depending on the physical configuration of the sensors 510, 250.

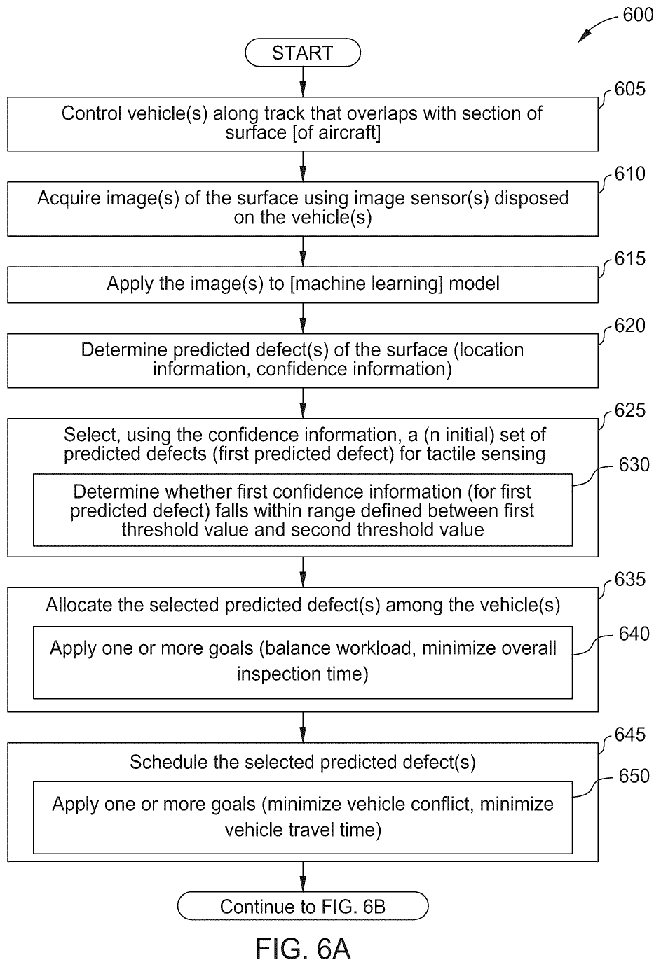

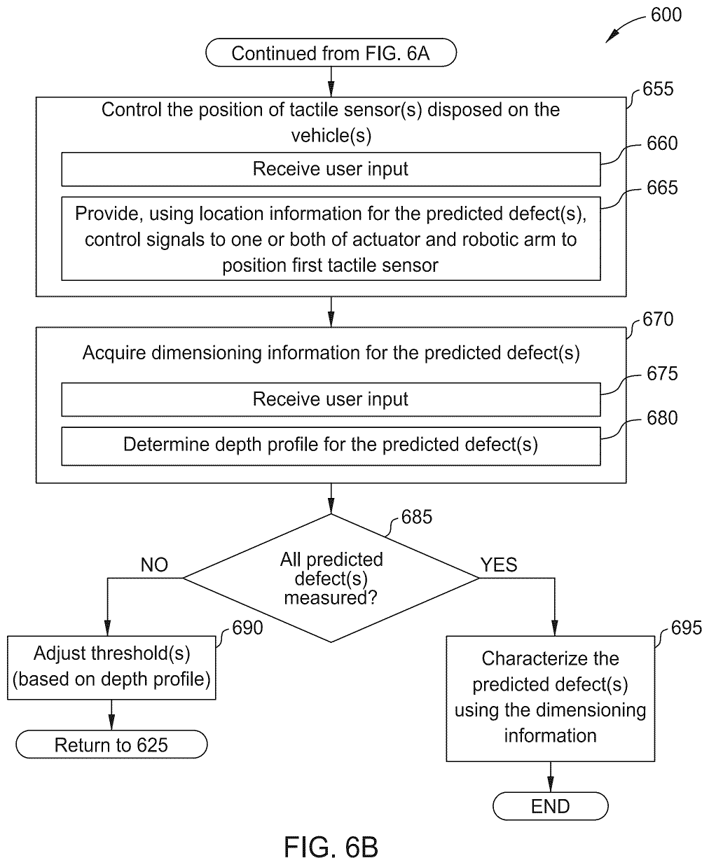

FIGS. 6A and 6B depict an exemplary method 600 of inspection of a surface of an aircraft fuselage, according to one or more aspects. The method 600 may be used in conjunction with other aspects, e.g., being performed by the inspection service 170 to inspect the surface 212. Further, although the method 600 is described in terms of an aircraft fuselage, these features are also applicable to surface inspection operations in other industries, especially those involving large-scale components.

The method 600 begins at block 605, where the inspection service 170 controls one or more vehicles along a track that overlaps with a section of a surface of an aircraft. At block 610, the inspection service 170 acquires one or more images of the surface using one or more image sensors disposed on the one or more vehicles. In some aspects, controlling the one or more vehicles comprises providing control signals to one or both of an actuator and a robotic arm to position the one or more image sensors to acquire the one or more images.

At block 615, the inspection service 170 applies the one or more images to a model (e.g., a machine learning model) to determine, at block 620, one or more predicted defects of the surface. In some aspects, the model provides location information and confidence information for the one or more predicted defects.

At block 625, the inspection service 170 selects, using the confidence information, an initial set of one or more predicted defects (including a first predicted defect) for tactile sensing using one or more tactile sensors disposed on the one or more vehicles. In some aspects, selecting the initial set of predicted defect(s) comprises, at block 630, determining whether first confidence information for the first predicted defect falls within a range defined between a first threshold value and a second threshold value, where the first threshold value is greater than the second threshold value. Selecting the initial set of predicted defect(s) may further include making a similar determination regarding confidence information for one or more other ones of the predicted defects.

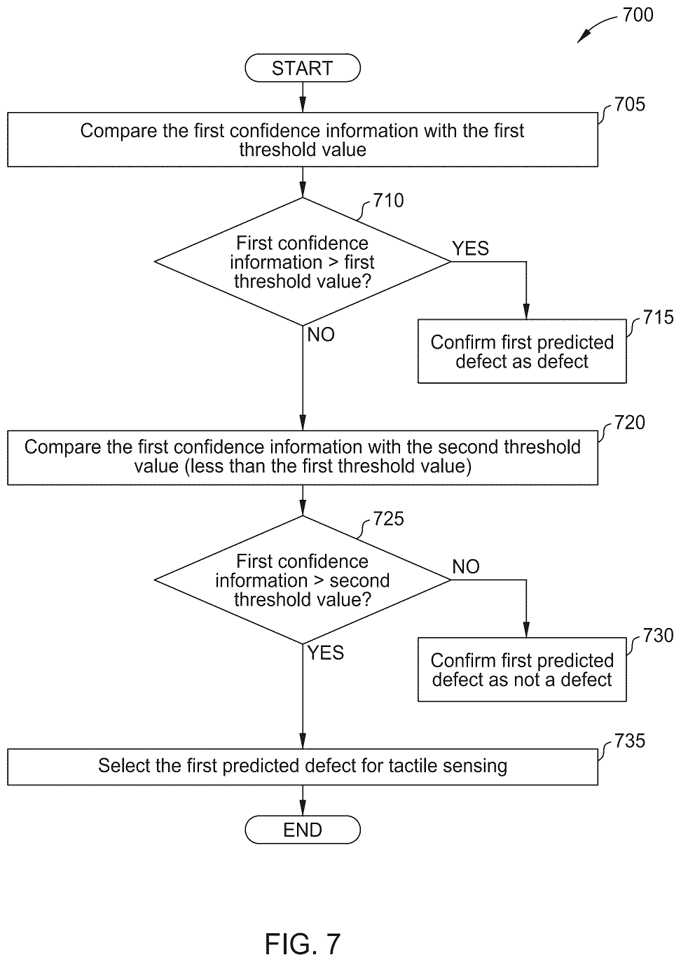

One example implementation of the blocks 625, 630 is shown as method 700 of FIG. 7. The method 700 begins at block 705, where the inspection service 170 compares the first confidence information with the first threshold value. If, at block 710, the first confidence information is greater than the first threshold value (“YES”), flow proceeds to block 715 and the inspection service 170 confirms the first predicted defect as a defect. In some aspects, 100% measurement of all defects may be required for certain applications. In such cases, the method 700 may proceed from the block 715 to block 735, where the first predicted defect is selected for tactile sensing.

If the first confidence information is less than the first threshold value (“NO”), flow proceeds to block 720 and the inspection service 170 compares the first confidence information with the second threshold value. If, at block 725, the first confidence information is less than the second threshold value (“NO”), flow proceeds to block 730 and the inspection service 170 confirms the first predicted defect as not a defect.

If the first confidence information is greater than the second threshold value (“YES”), flow proceeds to block 735 and the inspection service 170 selects the first predicted defect for tactile sensing. The method 700 ends following the completion of one of blocks 715, 730, or 735.

Returning to FIG. 6A, the inspection service 170 allocates, at block 635, the selected predicted defect(s) of the initial set among the one or more vehicles (e.g., those vehicle(s) having tactile sensors). In some aspects, allocating the selected predicted defect(s) among the one or more vehicles comprises applying, at block 640, one or more goals for optimizing the inspection process. In some aspects, the one or more goals include balancing workload among the vehicle(s) and/or minimizing an overall inspection time. In some aspects, the one or more goals may be based on the position of the vehicle(s) and/or the tactile sensor(s) (e.g., preferring tactile sensor(s) that are in closer proximity to the location of the predicted defect(s). Other optimization goals are also contemplated.

The inspection service 170 schedules, at block 645, the selected predicted defect(s) according to the allocation. In some aspects, scheduling the selected predicted defect(s) comprises applying, at block 650, one or more goals for optimizing the inspection process. In some aspects, the one or more goals include minimizing vehicle conflicts and/or minimizing vehicle travel time. Other optimization goals are also contemplated.

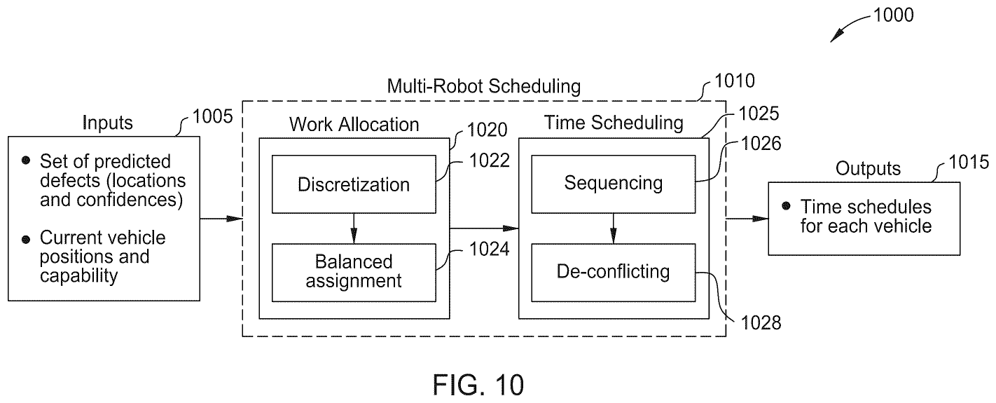

One example implementation for performing the blocks 635, 645 is shown in diagram 1000 of FIG. 10. For example, the inspection service 170 may include a multi-robot scheduling service 1010 that receives, as inputs 1005, a set of predicted defects including location information and confidence information. In some aspects, the inputs 1005 further include position information of the one or more vehicles, and capability information of the one or more vehicles (e.g., vehicle range, vehicle speed, types of sensors and/or robotic arms, and so forth).

In some aspects, the multi-robot scheduling service 1010 performs a work allocation operation 1020 using the inputs 1005. In some aspects, the work allocation operation 1020 comprises a discretization operation 1022 wherein a set of inspection-related tasks is defined and/or grouped. In some aspects, the work allocation operation 1020 further comprises an assignment operation 1024, where the set of inspection-related tasks are assigned (in some cases load-balanced) among the various vehicles.

In some aspects, the multi-robot scheduling service 1010 performs a scheduling operation 1025 using the inputs 1005. In some aspects, the scheduling operation 1025 comprises a sequencing operation 1026 for the set of inspection-related tasks. In some aspects, the sequencing operation 1026 prioritizes the various inspection-related tasks based on one or more parameters and/or one or more objectives. For example, the sequencing operation 1026 may prioritize predicted defects that have confidence values at the extremes of the range, and/or may prioritize predicted defects to maximize a cycle time efficiency.

In some aspects, the scheduling operation 1025 further comprises a de-conflicting operation 1028 to minimize vehicle conflicts occurring in the sequence generated by the sequencing operation 1026. The multi-robot scheduling service 1010 produces, as outputs 1015, a time schedule for each of the vehicles.

In some aspects, the multi-robot scheduling service 1010 includes supervisory control logic that determines when rescheduling by the scheduling operation 1025 should be performed. For example, the rescheduling may be performed responsive to user input, e.g., creating a new predicted defect within a teaching mode. The rescheduling may be performed responsive to an adjustment of a threshold for defect selection (e.g., increasing the number of predicted defects). The rescheduling may be performed responsive to changes detected within the environment (e.g., one or more of the vehicles or sensors becomes disabled, a human operator is detected in the path of the vehicles, and so forth).

Returning to FIG. 6, the inspection service 170 controls, at block 655, the position of the one or more tactile sensors. In some aspects, controlling the position of the one or more tactile sensors comprises receiving user input at block 660. For example, a human operator may intervene in the automated inspection process to manually identify an area for inspection. In some aspects, controlling the position of the one or more tactile sensors comprises (at block 665) providing, using location information for the predicted defect(s) (e.g., first location information for the first predicted defect), control signals to one or both of the actuator and the robotic arm to position a first tactile sensor. In some aspects, the one or more images are acquired with the one or more image sensors at a first distance from the surface, and controlling the position of the one or more tactile sensors comprises moving the first tactile sensor to a second distance from the surface (e.g., manipulating the robotic arm to position the first tactile sensor), where the second distance is less than the first distance.

At block 670, the inspection service 170 acquires dimensioning information for the predicted defect(s) (or other characteristic(s)) using the one or more tactile sensors. In some aspects, acquiring dimensioning information comprises receiving user input at block 675. In some aspects, acquiring the dimensioning information for the first predicted defect comprises determining one or more of a depth profile (at block 680), a width, a length, and a sharpness of a bottom basin for the first predicted defect. In some aspects, the one or more image sensors are unable to determine the dimensioning information that is acquired by the one or more tactile sensors (e.g., due to a relatively lower resolution, limited to 2D sensing).

At block 685, the inspection service 170 determines whether all of the predicted defects of the set have been measured (e.g., at block 670). In some aspects, if additional predicted defects remain (“NO”), the method 600 proceeds to block 690 and the inspection service 170 adjusts a threshold for selecting a set of predicted defects (e.g., based on the determined depth profiles at block 680). For example, the inspection service 170 may reduce a threshold value for the confidence information, and the method 600 returns to block 625 and an updated set of predicted detects is selected for tactile sensing.

In some aspects, if no additional predicted defects remain (“YES”), the method 600 proceeds to block 695, the inspection service 170 characterizes the first predicted defect using the dimensioning information. In some aspects, the first predicted defect is characterized as one of a drill run, a scratch, and a gouge. Other types or categories of characterizations are also contemplated, such as anomalies, discontinuities, irregular fastener installations, and so forth. In some aspects, the method 600 ends following the completion of block 695. In other aspects, where multiple predicted defects with a suitable confidence (e.g., confidence information within the range) are determined at block 620, flow returns to block 625 and a next predicted defect is selected for tactile sensing.

FIG. 8 is a diagram 800 illustrating an exemplary sequence of detecting and classifying one or more predicted defects of a surface, according to one or more aspects. The features depicted in the diagram 800 may be used in conjunction with other aspects. For example, the inspection service 170 may perform the sequence within the method 600 using the model 175, the one or more image sensors 140, and the one or more tactile sensors 150 of FIG. 1.

The two-stage sequence shown in the diagram 800 begins at Stage I (vision-based defect detection). Within an object detection pipeline 805, an input image 810 of a section of a surface is acquired by the one or more image sensors 140. In some aspects, one or more augmentation techniques (e.g., photometric, CutAndPaste, translation) are applied to the input image 810. The input image 810 is applied to the model 175, which is represented in the diagram 800 as a backbone model 815, a regression model 820, and a classifier model 830. In some aspects, the backbone model 815 is a MobileNet-V3 Convolutional Backbone and the regression model 820 is a Region Proposal Network, e.g., a fully convolutional network such as a Faster Region-based CNN. The backbone model 815 outputs to the regression model 820, which outputs one or more proposals 825 for the predicted defects into the classifier model 830. The backbone model 815 also outputs to the classifier model 830. The classifier model 830 outputs one or more bounding box predictions 835 for the input image 810. Each of the one or more bounding box predictions 835 includes location information (e.g., coordinates of the rectangle region in the camera coordinate frame) and confidence information (e.g., a defect class and a confidence score for that class).

In some aspects, each of the one or more bounding box predictions 835 is assessed by the inspection service 170 using the method 700 to determine whether to proceed to Stage II (tactile-based defect detection). In some aspects, the inspection service 170 confirms those bounding boxes having a confidence score greater than a first threshold value (e.g., 0.7) as defects, confirms those bounding boxes having a confidence score less than a second threshold value (e.g., 0.1) as not defects, and proceed to Stage II for those bounding boxes with confidence scores between the first threshold value and the second threshold value. The first threshold value and the second threshold value may be selected to provide a desired balance between detections in Stage I and minimal false positives in Stage II.

In Stage II, the inspection service 170 controls the position of the one or more tactile sensors 150 to image the selected bounding box predictions 835. As shown, the one or more tactile sensors 150 acquires a heightfield 840 for a selected bounding box prediction 835.

Because the heightfield 840 is high resolution, the anomalous regions may be directly inspected and identified using the defect class. In some aspects, edge detection is performed on the heightfield 840 using canny edge detection without non-maximal suppression. In some aspects, feature detection processing is also performed on the heightfield 840 based on the defect class (e.g., Probabilistic Hough line for scratches and drill run defect classes; Hough Circle detection for gouge defect classes).

The edge detection output 845 is used to extract depth profiles 860, 865 for identified anomalous regions such as a scratch 850 and noise (or gouge) 855. In some aspects, a line segment is generated perpendicular to the scratch 850 (or a drill run), and a line segment is generated passing through a center of a gouge. After extracting the depth profiles 860, 865, the depth may be de-trended by assuming the depth adjacent to the defect is zero-level. The depth and width information may be used to confirm the defect in the extracted depth profile 860, 865. In some aspects, to confirm a drill run defect, the count of minima peaks with a threshold depth (e.g., greater than 10 microns) must be greater than a threshold count (e.g., greater than 3).

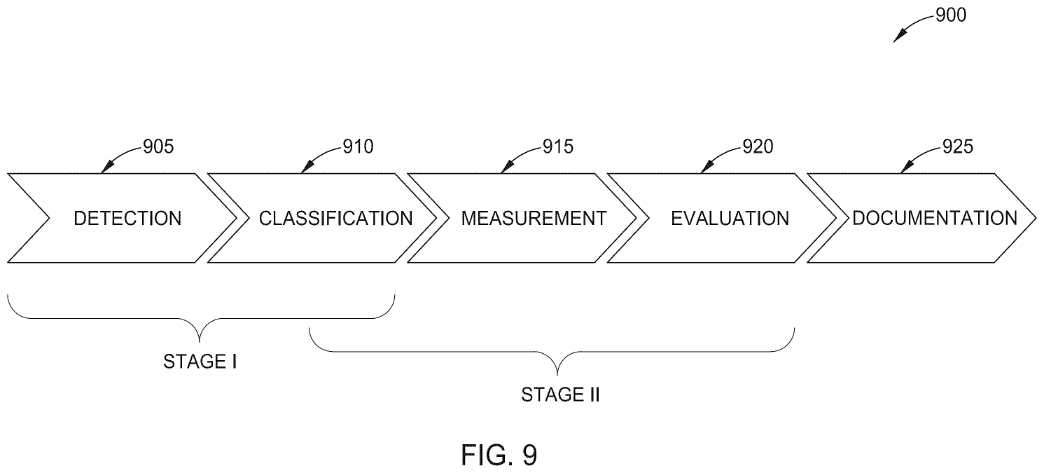

FIG. 9 is a diagram 900 illustrating an exemplary inspection process, according to one or more aspects. The features of the diagram 900 may be used in conjunction with other aspects. For example, the diagram 900 represents exemplary phases of the inspection process where the operations of Stage I and Stage II of FIG. 8 may be performed.

The inspection process includes a detection phase 905, a classification phase 910, a measurement phase 915, an evaluation phase 920, and a documentation phase 925 in sequence. Stage I overlaps with the detection phase 905 and the classification phase 910. Stage II overlaps with the classification phase 910, the measurement phase 915, and the evaluation phase 920. Further, Stage II partly overlaps Stage I within the classification phase 910.

In some aspects, and as discussed above, performing the operations of Stage II may be performed in the classification phase 910 (e.g., in conjunction with the process of method 700) to improve the confidence of an identified defect through the tactile sensing of Stage II. In other aspects (e.g., depending on the particular application), responsive to a high classification confidence in Stage I, the inspection process proceeds from the classification phase 910 into the measurement phase 915. For example, some applications might only want to detect the presence of the defects (e.g., the classification phase 910), and other applications might require that all identified defects are 100% measured and evaluated.

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method of inspection of a surface of an aerodynamic structure, the method comprising:
acquiring one or more images of the surface using one or image sensors disposed adjacent to the surface;
determining, using the one or more images applied to a model, one or more predicted defects of the surface and corresponding location information;
controlling, using the location information, the position of one or more tactile sensors disposed adjacent to the surface to acquire dimensioning information for at least a first predicted defect of the one or more predicted defects; and
characterizing the first predicted defect using the dimensioning information.

2. The method of claim 1, further comprising:
applying the one or more images to a machine learning model to identify the one or more predicted defects and the location information;
selecting, using confidence information corresponding to the one or more predicted defects, at least a first predicted defect from the one or more predicted defects; and
providing, using the location information corresponding to the first predicted defect, a control signal to the vehicle to position a first tactile sensor of the one or more tactile sensors to acquire the dimensioning information for the first predicted defect.

3. The method of claim 2, wherein a first image sensor of the one or more image sensors, used to acquire the one or more images, and the first tactile sensor are colocated on a vehicle disposed adjacent to the surface.

4. The method of claim 2, wherein selecting at least a first predicted defect comprises:
selecting, based on a comparison of the confidence information with a threshold value, a set of the one or more predicted defects for tactile sensing;
allocating the predicted defects of the set among one or more vehicles disposed adjacent to the surface; and
scheduling the predicted defects of the set among the one or more vehicles.

5. The method of claim 4, wherein allocating the predicted defects of the set among the one or more vehicles comprises:
applying one or more goals, wherein the one or more goals comprises one or more of balancing a workload between the one or more vehicles, and minimizing an overall inspection time.

6. The method of claim 4, wherein scheduling the predicted defects of the set among the one or more vehicles comprises:
applying one or more goals, wherein the one or more goals comprises one or more of minimizing conflicts between the one or more vehicles, and minimizing a travel time of the one or more vehicles.

7. The method of claim 4, further comprising:
adjusting the threshold value; and
selecting, based on a comparison of the confidence information with the adjusted threshold value, a second set of the one or more predicted defects for tactile sensing.

8. The method of claim 1, wherein acquiring the dimensioning information for the first predicted defect comprises:
determining one or more of a depth profile, a width, a length, and a sharpness of a bottom basin for the first predicted defect.

9. The method of claim 1, wherein characterizing the first predicted defect using the dimensioning information comprises:
characterizing the first predicted defect as one of a drill run, a scratch, and a gouge.

10. A computer program product comprising:
a computer-readable storage medium having computer-readable program code embodied therewith, the computer-readable program code executable by one or more computer processors to perform an operation comprising:
acquiring one or more images of surface of an aerodynamic structure using one or image sensors;
determining, using the one or more images applied to a model, one or more predicted defects of the surface and corresponding location information;
controlling, using the location information, the position of one or more tactile sensors to acquire dimensioning information for at least a first predicted defect of the one or more predicted defects; and
characterizing the first predicted defect using the dimensioning information.

11. The computer program product of claim 10, the operation further comprising:
applying the one or more images to a machine learning model to identify the one or more predicted defects and the location information;
selecting, using confidence information corresponding to the one or more predicted defects, at least a first predicted defect from the one or more predicted defects; and
providing, using the location information corresponding to the first predicted defect, a control signal to the vehicle to position a first tactile sensor of the one or more tactile sensors to acquire the dimensioning information for the first predicted defect.

12. The computer program product of claim 11, wherein a first image sensor of the one or more image sensors, used to acquire the one or more images, and the first tactile sensor are colocated on a vehicle disposed adjacent to the surface.

13. The computer program product of claim 11, wherein selecting at least a first predicted defect comprises:
selecting, based on a comparison of the confidence information with a threshold value, a set of the one or more predicted defects for tactile sensing;
allocating the predicted defects of the set among one or more vehicles disposed adjacent to the surface; and
scheduling the predicted defects of the set among the one or more vehicles.

14. The computer program product of claim 13, wherein allocating the predicted defects of the set among the one or more vehicles comprises:
applying one or more goals, wherein the one or more goals comprises one or more of balancing a workload between the one or more vehicles, and minimizing an overall inspection time.

15. The computer program product of claim 13, wherein scheduling the predicted defects of the set among the one or more vehicles comprises:
applying one or more goals, wherein the one or more goals comprises one or more of minimizing conflicts between the one or more vehicles, and minimizing a travel time of the one or more vehicles.

16. The computer program product of claim 13, the operation further comprising:
adjusting the threshold value; and
selecting, based on a comparison of the confidence information with the adjusted threshold value, a second set of the one or more predicted defects for tactile sensing.

17. The computer program product of claim 10, wherein acquiring the dimensioning information for the first predicted defect comprises:
determining one or more of a depth profile, a width, a length, and a sharpness of a bottom basin for the first predicted defect.

18. The computer program product of claim 10, wherein characterizing the first predicted defect using the dimensioning information comprises:
characterizing the first predicted defect as one of a drill run, a scratch, and a gouge.

19. A system comprising:
one or more image sensors disposed adjacent to a surface of an aerodynamic structure;
one or more tactile sensors disposed adjacent to the surface; and
one or more processors configured to:
acquire one or more images of the surface using the one or image sensors;
determine, using the one or more images applied to a model, one or more predicted defects of the surface and corresponding location information;
control, using the location information, the position of the one or more tactile sensors to acquire dimensioning information for at least a first predicted defect of the one or more predicted defects; and
characterize the first predicted defect using the dimensioning information.

20. The system of claim 19, wherein a first image sensor of the one or more image sensors, used to acquire the one or more images, and the first tactile sensor are colocated on a vehicle disposed adjacent to the surface.
